(19) United States
(12) Patent Application Publication
(10) Pub. No.: US 2026/0036184 A1
(43) Pub. Date: Feb. 5, 2026

(54) HYDRAULIC MOUNT

(71) Applicants: Hyundai Motor Company, Seoul (KR); Kia Corporation, Seoul (KR)

(72) Inventor: Jae Hyung Yun, Hwaseong-si (KR)

(73) Assignees: Hyundai Motor Company, Seoul (KR); KIA Corporation, Seoul (KR)

(21) Appl. No.: 19/184,787

(22) Filed: Apr. 21, 2025

(30) Foreign Application Priority Data
Jul. 30, 2024 (KR) 10-2024-0100888

(51) Int. Cl. F16F 13/14; B60K 1/00

(52) U.S. Cl. CPC F16F 13/1463; B60K 1/00; F16F 2230/30; F16F 2234/02

(57) ABSTRACT

A hydraulic mount includes an internal core, an internal core flow path portion formed on an external circumferential surface of the internal core, wherein the internal core flow path portion includes a flow path formed on a surface thereof and configured to allow mount fluid to flow therethrough, and a main insulator located to surround the internal core flow path portion, wherein the internal core flow path portion has two flow paths respectively formed on one surface and the other surface thereof, wherein the respective flow paths are formed to have a predetermined angle relative to a central axis of the internal core flow path portion.

### CROSS-REFERENCE TO RELATED APPLICATION

The present application claims priority to Korean Patent Application No. 10-2024-0100888, filed on Jul. 30, 2024, the entire contents of which is incorporated herein for all purposes by this reference.

### BACKGROUND OF THE PRESENT DISCLOSURE

### Field of the Present Disclosure

The present disclosure relates to a hydraulic mount, and more particularly, to a hydraulic mount configured to control and damp a behavior of a motor mounted on a vehicle body.

### Description of Related Art

In an internal combustion engine vehicle, the vehicle is driven by an internal combustion engine, whereas in an eco-friendly vehicle such as an electric vehicle, the vehicle is driven by a motor. To isolate vibration and noise generated by road surface conditions, driving of an engine or a motor, power transmission, and the like and transmitted from an engine or a motor to a vehicle body, both the engine of the internal combustion engine vehicle and the motor of the eco-friendly vehicle are mounted on the vehicle through an engine mount or a motor mount, respectively.

Meanwhile, a unidirectional high-damping mount mainly used in the internal combustion engine has a large number of parts including a diaphragm and the like to form an upper chamber of the unidirectional high-damping mount and a lower chamber thereof. The present structural configuration is not suitable to form a two-way system. Furthermore, it is difficult to implement characteristics required in an electric vehicle due to shape constraints of an insulator provided to secure a chamber area and a damping area.

In the case of electric vehicles that are currently in mass production, a single-axial high damping structure in the height direction, or a two-way fluid mount is used. Here, the conventional two-way fluid mount has a flow path formed on the external side of an insulator, which limits a flow path configuration. Accordingly, there are restrictions on a target frequency and a damping value.

Furthermore, to achieve improvement in axial characteristics, a protrusion called a bulge is disposed on an internal pipe, or a separate structure is inserted thereinto. However, the present structural configuration causes deterioration in hydraulic performance of a fluid mount, and the number of parts increases due to the separate structure inserted into the internal pipe. Therefore, manufacturing costs increase due to high material costs.

Accordingly, to solve the limitations of the conventional technology, it is required to combine a structure for improvement in axial characteristics with a hydraulic unit, and it is also required to secure a degree of freedom for a design of the length and width of a flow path configured to achieve hydraulic mount performance.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a hydraulic mount including a flow path formed therein, in which the hydraulic mount has a wide range of applications for directionally (upward-and-downward direction and leftward-and-rightward direction) required frequencies and provides a high damping value.

It is another object of the present disclosure to provide a hydraulic mount configured not only to implement damping performance for two behavioral axes by applying a two-way damping structure thereto, but also to implement damping performance for a complexly generated vector directional component.

It is a further object of the present disclosure to provide a hydraulic mount including a flow path structure configured to support an axial insulator bridge, not only having an effect of achieving improvement in axial rigidity but also having a mass effect by the flow path structure. In the present manner, the hydraulic mount is configured as a mass damper and may further improve high-frequency dynamic characteristics.

The objects of the present disclosure are not limited to the above-mentioned objects, and other technical objects not mentioned herein will be clearly understood by those skilled in the art to which the present disclosure pertains from the DETAILED DESCRIPTION. Additionally, the objects of the present disclosure may be achieved by means and combinations thereof as indicated in the claims.

In one aspect, the present disclosure provides a hydraulic mount including an internal core, an internal core flow path portion formed on an external circumferential surface of the internal core, wherein the internal core flow path portion includes a flow path formed on a surface thereof and configured to allow mount fluid to flow therethrough, and a main insulator located to surround the internal core flow path portion, wherein the internal core flow path portion has two flow paths respectively formed on one surface and the other surface thereof, wherein the respective flow paths are formed to have a predetermined angle relative to a central axis of the internal core flow path portion.

In an exemplary embodiment of the present disclosure, the two flow paths may include a first flow path located on the one surface of the internal core flow path portion and a second flow path located on the other surface opposite to the one surface of the internal core flow path portion, and the two flow paths may be formed to allow the mount fluid to flow along the one surface and the other surface of the internal core flow path portion.

In another exemplary embodiment of the present disclosure, the first flow path may include a first inlet configured to allow the mount fluid to be introduced into the first inlet and a first outlet configured to discharge the mount fluid introduced into the first inlet through the first outlet, wherein the first inlet may be located at an upper portion of the main insulator in a height direction, and the first outlet may be located at a lower portion thereof in the height direction.

In yet another exemplary embodiment of the present disclosure, the second flow path may include a second inlet configured to allow the mount fluid to be introduced into the second inlet and a second outlet configured to discharge the mount fluid through the second outlet, wherein the second inlet and the second outlet may be respectively located on opposite sides of the main insulator in the axial direction of the main insulator.

In yet another exemplary embodiment of the present disclosure, each of the flow paths may have a diameter or a length determined depending on an amount of the mount fluid flowing through each of the flow paths, and damping or target frequency may be set depending on the diameter or the length of each of the flow paths.

In still yet another exemplary embodiment of the present disclosure, the hydraulic mount may further include plates each covering a corresponding one of surfaces of the two flow paths.

In a further exemplary embodiment of the present disclosure, the hydraulic mount may further include a middle pipe located to surround an external circumferential surface of the main insulator.

In another further exemplary embodiment of the present disclosure, the hydraulic mount may further include an external pipe located to surround an external circumferential surface of the middle pipe.

In yet another further exemplary embodiment of the present disclosure, the two flow paths of the internal core flow path portion may be respectively formed to be recessed in the one surface and the other surface of the internal core flow path portion.

In yet another further exemplary embodiment of the present disclosure, the internal core and the internal core flow path portion may be manufactured by integral injection molding.

Other aspects and exemplary embodiments of the present disclosure are discussed infra.

It is understood that the terms “vehicle”, “vehicular”, and other similar terms as used herein are inclusive of motor vehicles in general, such as passenger vehicles including sports utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The methods and apparatuses of the present disclosure have other features and advantages which will be apparent from or are set forth in more detail in the accompanying drawings, which are incorporated herein, and the following Detailed Description, which together serve to explain certain principles of the present disclosure. The above and other features of the present disclosure are discussed infra.

### BRIEF DESCRIPTION OF THE DRAWINGS

FIG. 1 is a perspective view showing a hydraulic mount of the present disclosure;

FIG. 2 is exploded perspective views sequentially showing the order of assembling the hydraulic mount of the present disclosure;

FIG. 3 is a view showing a flow path of an internal core flow path portion of the hydraulic mount according to an exemplary embodiment of the present disclosure, and is an exemplary view showing movement of fluid in the upward-and-downward direction and the leftward-and-rightward direction thereof;

FIG. 4A is a view showing a first flow path located on one surface of the internal core flow path portion of the present disclosure;

FIG. 4B is a view showing a second flow path located on the other surface of the internal core flow path portion of the present disclosure;

FIG. 5 is a perspective view showing a state in which the internal core flow path portion of the hydraulic mount according to the exemplary embodiment of the present disclosure and an internal core thereof are separately manufactured; and

FIG. 6 is a perspective view showing a state in which an internal core flow path of a hydraulic mount according to another exemplary embodiment of the present disclosure and an internal core thereof are manufactured as an injection-molded structure.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, reference will be made in detail to various embodiments of the present disclosure, examples of which are illustrated in the accompanying drawings and described below. Furthermore, the matters represented in the accompanying drawings are schematically illustrated to easily explain the exemplary embodiments of the present disclosure, and may be different from actually implemented forms.

When a portion “comprises” or “includes” a predetermined component throughout the specification, this means that the portion may further include or include other components without excluding the other components unless stated otherwise.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to”, should be interpreted in the same manner.

Hereinafter, various exemplary embodiments will be described in detail with reference to the accompanying drawings. In describing the exemplary embodiments with reference to the accompanying drawings, the same or corresponding components will be denoted by the same reference numerals and redundant description thereof will be omitted.

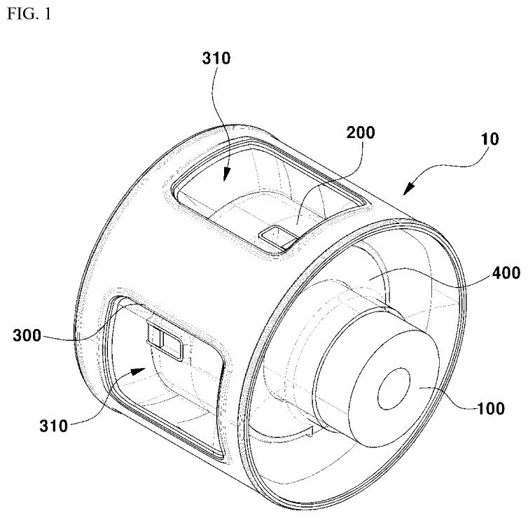

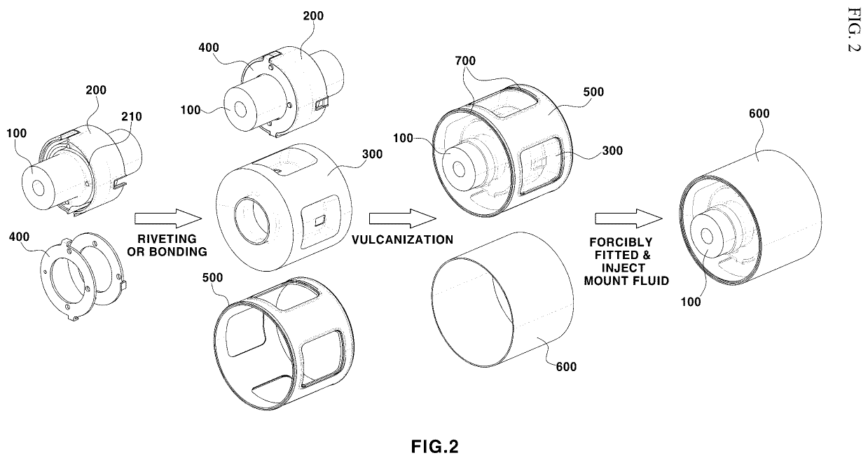

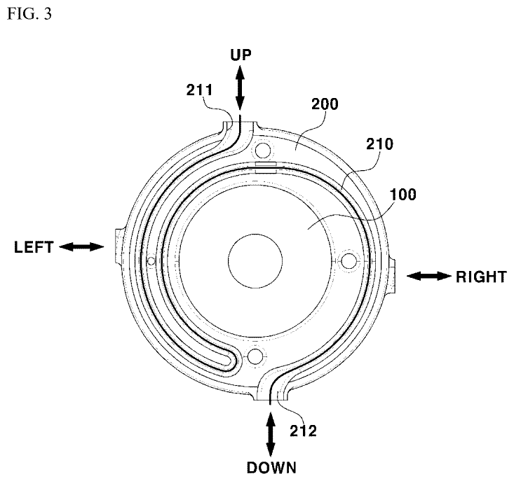

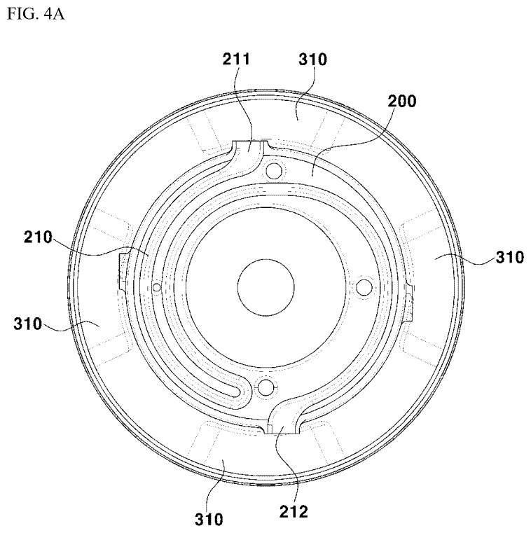

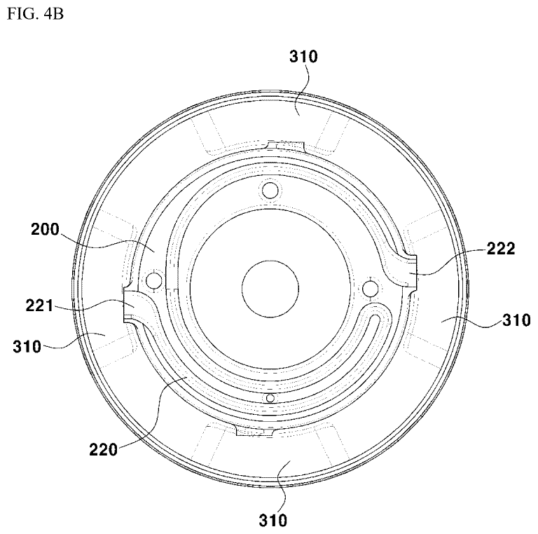

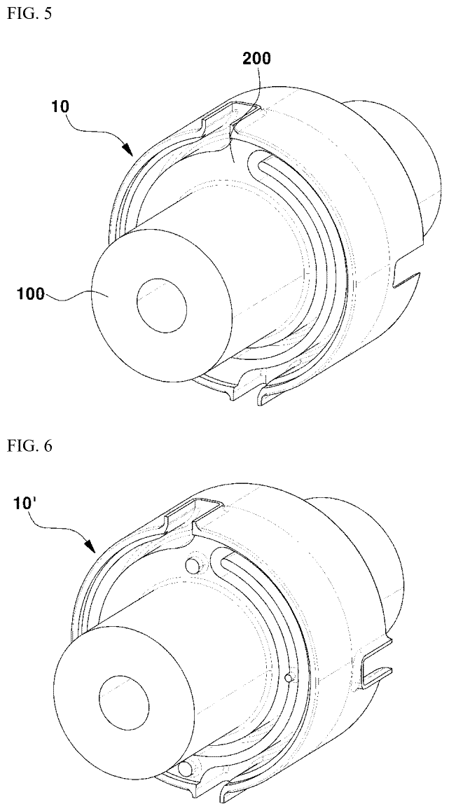

FIG. 1 is a perspective view showing a hydraulic mount of the present disclosure, FIG. 2 is exploded perspective views sequentially showing the order of assembling the hydraulic mount of the present disclosure, FIG. 3 is a view showing a flow path of an internal core flow path portion of the hydraulic mount according to an exemplary embodiment of the present disclosure, and is an exemplary view showing movement of fluid in the upward-and-downward direction and the leftward-and-rightward direction, FIG. 4A is a view showing a first flow path located on one surface of the internal core flow path portion of the present disclosure, FIG. 4B is a view showing a second flow path located on the other surface of the internal core flow path portion of the present disclosure, FIG. 5 is a perspective view showing a state in which the internal core flow path of the hydraulic mount according to the exemplary embodiment of the present disclosure and an internal core thereof are separately manufactured, and FIG. 6 is a perspective view showing a state in which an internal core flow path of a hydraulic mount according to another exemplary embodiment of the present disclosure and an internal core thereof are manufactured as an injection-molded structure.

Meanwhile, the hydraulic mount of the present disclosure is used in an electric vehicle. Since motor modules are respectively mounted on a front wheel and a rear wheel, there is a problem in that shaking, vibration, or other movement in the upward-and-downward direction becomes severe when a vehicle travels on the flat road surface.

To address the above-mentioned problem, the present disclosure provides a hydraulic mount 10 having improved characteristics in the axial direction and the load supporting direction.

The hydraulic mount 10 of the present disclosure is formed to include a structure in which damping characteristics in two or more directions are increased in the radial direction relative to the axis of an internal core of the hydraulic mount 10, effectively damping vibration in two directions of a vehicle.

Hereinafter, unless stated otherwise, the “axial direction” may mean the central axial direction of the hydraulic mount 10 including an internal core 100 and the like and may include the same meaning as the “forward-and-rearward direction” or the “vehicle forward-and-rearward direction”. Furthermore, unless stated otherwise, the “upward-and-downward direction” or the “height direction” may mean the upward-and-downward direction in the drawing. The load supporting direction may mean a direction in which an inlet and an outlet of two flow paths formed in the hydraulic mount 10 are formed. Furthermore, unless stated otherwise, the “radial direction” may mean the radial direction of the hydraulic mount 10 including the internal core 100 and the like.

According to an exemplary embodiment of the present disclosure, as shown in FIG. 1, FIG. 2, FIG. 3, FIG. 4A and FIG. 4B, and FIG. 5, the hydraulic mount 10 may include the internal core 100, an internal core flow path portion 200, a main insulator 300, plates 400, a middle pipe 500, and an external pipe 600. Here, the middle pipe 500 and an external pipe 600 are coaxially disposed.

First, the internal core 100 of the present disclosure may be coupled to a motor module through a coupling member and may transmit a load of the motor module to the internal core flow path portion 200.

Next, the internal core flow path portion 200 of the hydraulic mount 10 according to the exemplary embodiment of the present disclosure is formed on the external circumferential surface of the internal core 100. Furthermore, the internal core flow path portion 200 has flow paths 210 and 220 respectively formed on the opposite side surfaces thereof, in which the flow paths 210 and 220 accommodate mount fluid therein and allow the mount fluid to flow therethrough. The internal core 100 of the present disclosure is formed to include a shape of cylinder, and the internal core flow path portion 200 is configured to be coaxially disposed with the internal core 100 and to surround at least a portion of the internal core 100.

Furthermore, the first flow path 210 is formed on one surface of the internal core flow path portion 200, and the second flow path 220 is formed on the other surface opposite to the one surface of the internal core flow path portion 200, allowing the mount fluid to be movable on the one surface and the other surface of the internal core flow path portion 200, respectively.

The first flow path 210 and the second flow path 220 are respectively provided on opposite side surfaces of the internal core flow path portion 200 and are each formed to be recessed in an intaglio shape. Here, the plates 400 are respectively disposed on the opposite side surfaces of the internal core flow path portion 200 to seal the first flow path 210 and the second flow path 220.

Referring to FIGS. 3, 4A, and 4B, the first flow path 210 and the second flow path 220 of the present disclosure may include inlets 211 and 221 into which the mount fluid is introduced and outlets 212 and 222 through which the mount fluid is discharged, in which the inlets 211 and 221 and the outlets 212 and 222 are respectively located on the front surface and the rear surface of the internal core flow path portion 200. Here, the inlet 211 of the first flow path 210 and the inlet 221 of the second flow path 220 are located to include a predetermined interval therebetween in the radial direction of the internal core flow path portion 200. Furthermore, the outlet 212 of the first flow path 210 may be located to form an angle of 180 degrees relative to the inlet 211 of the first flow path 210, and the outlet 222 of the second flow path 220 may be located to form an angle of 180 degrees relative to the inlet 221 of the second flow path 220.

In the exemplary embodiment of the present disclosure, with respect to the central axis of the internal core flow path portion 200, the inlet 211 and the outlet 212 are located to from an angle of 180 degrees therebetween, and the inlet 221 and the outlet 222 are located to from an angle of 180 degrees therebetween, providing damping performance in response to external force in a longitudinal direction in which the inlets 211 and 221 and the outlets 212 and 222 extend.

Furthermore, the internal core 100 and internal core flow path portion 200 of the present disclosure may be manufactured as either an integral structure or a separate structure. In the instant case, the first flow path 210 and the second flow path 220 manufactured as the integral structure may also be formed to have the same shapes as those of the first flow path 210 and the second flow path portion 220 manufactured as the separate structure. Here, the internal core 100 and the internal core flow path portion 200 may be manufactured through an integral injection molding method. Furthermore, the internal core 100 and the internal core flow path portion 200 manufactured as the separate structure may be configured so that after the internal core 100 and the internal core flow path portion 200 are respectively manufactured, the same are forcibly coupled to each other.

The first flow path 210 and the second flow path 220 of the present disclosure are respectively formed on the opposite side surfaces of the internal core flow path portion 200. Here, the first flow path 210 and the second flow path 220 are respectively formed in the radial direction from the inlets 211 and 221 to the outlets 212 and 222 along the circumference of the internal core flow path portion 200. Furthermore, the first flow path 210 and the second flow path 220 are formed to circulate, from the direction of the outlets 212 and 222, the circumferences of the respective side surfaces along the diameter again.

The mount fluid introduced into each of the inlets 211 and 221 flows along a flow path adjacent to the external circumferential surface of the internal core flow path portion 200, and the flow direction of the mount fluid is changed at a position adjacent to each of the outlets 212 and 222. As a result, the mount fluid may be circulated 360 degrees relative to the central axis of the internal core flow path portion 200 and may be discharged through each of the outlets 212 and 222. The mount fluid flowing along each of the inlets 211 and 221 and each of the outlets 212 and 222 is stored in a chamber 310 formed in the main insulator 300 and is configured to flow to the first flow path 210 and/or the second flow path 220 by external force.

Furthermore, the flow paths 210 and 220 of the present disclosure may be respectively located on one surface and the other surface of the internal core flow path portion 200. Here, the first flow path 210 may be formed on one surface to reduce vibration generated in the upward-and-downward direction, and the second flow path 220 may be formed on the other side to reduce vibration generated in the leftward-and-rightward direction. As described above, although the first flow path 210 is formed on one surface of the internal core flow path portion 200, and the second flow path 220 is formed on the other surface thereof, the first flow path 210 may be formed on the other surface of the internal core flow path portion 200, and the second flow path 220 may be formed on one surface thereof., the present disclosure is not limited to the above-described structural configuration. Furthermore, the present disclosure is provided to reduce vibration generated from a motor and a reducer. Here, to reduce vibration generated in the upward-and-downward direction on one surface of the internal core flow path portion 200 and to reduce vibration generated in the leftward-and-rightward direction on the other surface, the first flow path 210 may include the inlet 211 and the outlets 212 located to have a predetermined angle therebetween, and the second flow path 220 may include the inlet 221 and the outlets 222 located to have a predetermined angle therebetween.

Referring to FIG. 4A, the first flow path 210 of the present disclosure is formed with the first inlet 211 configured to allow the mount fluid to be introduced thereinto and the first outlet 212 configured to allow the mount fluid to be discharged therethrough. Here, the first inlet 211 may be located at an upper portion of the internal core flow path portion 200 in the height direction, and the first outlet 212 may be located at a lower portion of the internal core flow path portion 200 in the height direction. The first inlet 211 and the first outlet 212 of the first flow path 210 may be respectively located to face the chambers 310 respectively located at the upper and lower end portions of the main insulator 300.

Meanwhile, referring to FIG. 4B, the second flow path 220 of the present disclosure is formed with the second inlet 221 configure to allow the mount fluid to be introduced thereinto and the second outlet 212 configured to allow the mount fluid to be discharged therethrough. Here, the second inlet and the second outlet may be respectively located to form a predetermined angle therebetween in the height direction of the internal core flow path portion 200. The second inlet 221 and the second outlet 222 of the second flow path 220 may be respectively located to face the chambers 310 respectively located at the side end portions of the main insulator 300.

Here, the chambers 310 may be independently located in the main insulator 300. As described above, the chambers 310 are fluidically connected to the first inlet 211 and the first outlet 212 of the first flow path 210, respectively. Furthermore, the chambers 310 are fluidically connected to the second inlet 221 and the second outlet 222 of the second flow path 220, respectively. Additionally, the chambers 310 may be configured to be sealed by the middle pipe 500.

In the exemplary embodiment of the present disclosure, the flow paths 210 and 220 each including a separate structure may be formed to have the same shape and position in a structure in which the internal core 100 and the internal core flow path portion 200 are integrally injection-molded.

Meanwhile, referring to FIG. 4A and FIG. 4B, the first flow path 210 is formed on one surface of the internal core flow path portion 200 of the present disclosure, and the second flow path 220 is formed on the other surface thereof. A direction formed by the first inlet 211 and the first outlet 212 of the first flow path 210 and a direction formed by the second inlet 221 and the second outlet 222 of the second flow path 220 may be located to form a predetermined angle relative to the central axis of the internal core 100.

In the exemplary embodiment of the present disclosure, as shown in the drawings, the first inlet 211 and the first outlet 212 of the first flow path 210 may be located to form an angle of 180 degrees, and the second inlet 221 and the second outlet 222 of the second flow path 220 may be respectively disposed at locations each having an angle such as 45 degrees relative to a corresponding one of the first inlet 211 and the first outlet 212 in the clockwise or counterclockwise direction. The first inlet 211 and the first outlet 212 are located to be spaced apart from the second inlet 221 and the second outlet 222 in the longitudinal direction.

As described above, the first flow path 210 for vertical damping and the second flow path 220 for horizontal damping of the present disclosure are provided on one surface of the internal core flow path portion 200 and the other surface thereof, respectively. Accordingly, the first flow path 210 and the second flow path 220 may be fluidically connected to different chambers 310 provided in the main insulator 300 and formed to respectively face the first flow path 210 and the second flow path 220. Furthermore, since the main insulator 300 is supported by the structure of the internal core flow path portion 200 including two different flow paths, making it possible to achieve improvement in axial characteristics.

That is, in the exemplary embodiment of the present disclosure, the first flow path 210 includes the inlet 211 and the outlet 212 respectively located at the upper end portion and the lower end portion of the internal core flow path portion 200 in the height direction, performing absorbing external force generated in the height direction. Furthermore, the second flow path 220 includes the inlet 221 and the outlet 222 formed to have a predetermined angle therebetween in the height direction, absorbing external force applied in a direction in which the inlet 221 and the outlet 222 extend.

Depending on the amount of mount fluid flowing through the flow paths 210 and 220 of the internal core flow path portion 200 of the present disclosure, the diameter or the length of each of the flow paths 210 and 220 may be determined, and the size of each of the chambers 310 of the main insulator 300 facing a corresponding one of the flow paths may be determined. Furthermore, damping or target frequency may be set depending on the diameter or the length of each of the flow paths 210 and 220 and the size of each chamber 310.

According to an exemplary embodiment of the present disclosure, vibration is generated from a motor and a reducer in a specific frequency band by external force of a vehicle using electricity as power. Here, to reduce the vibration in the specific frequency band, an amount of mount fluid flowing through the flow paths 210 and 220 of the internal core flow path portion 200 may be determined, and the diameter of each of the flow paths 210 and 220 may be made wide or narrow depending on the amount of mount fluid. Furthermore, the first flow path 210 and the second flow path 220 may be formed to extend in the longitudinal direction thereof.

As described above, in the case of a vehicle using electricity as a power source, to reduce vibration of a specific frequency band in a motor and a reducer, the mount 10 of the present disclosure may include the first flow path 210 and the second flow path 220 respectively formed on one surface and the other surface of the internal core flow path portion 200 and may adjust the amount of mount fluid flowing through the first flow path 210 and the second flow path 220. Furthermore, the diameter or the length of each of the first flow path 210 and the second flow path 220 may be appropriately changed depending on the amount of mount fluid. Accordingly, it is possible to provide a high damping value for the required frequency generated in the upward-and-downward direction and the leftward-and-rightward direction. Furthermore, since the length of each of the flow paths 210 and 220 may be appropriately extended or the diameter thereof may be appropriately increased, an application range with respect to the required frequency is wide, making it possible to apply a higher damping value than that of the related art.

Next, the main insulator 300 of the hydraulic mount 10 according to the exemplary embodiment of the present disclosure is located between the internal core flow path portion 200 and the middle pipe 500 to be described later. Furthermore, the main insulator 300 is formed to prevent frequency and vibration generated from a motor and a reducer, and it is desirable to adopt a material configured for performing a cushioning function or reducing vibration.

Additionally, the plates 400 of the hydraulic mount 10 according to the exemplary embodiment of the present disclosure are respectively located on the opposite side surfaces of the two flow paths of the internal core flow path portion 200. The plates 400 of the present disclosure are provided to surround the open opposite side surfaces respectively forming the first flow path 210 and the second flow path 220 of the internal core flow path portion 200. Furthermore, the plates 400 are adopted to prevent leakage of the mount fluid flowing through the first flow path 210 and the second flow path 220 and are assembled with the internal core flow path portion 200.

Here, after the internal core 100 and the internal core flow path portion 200 are coupled to each other, the plates 400 are configured to respectively seal the flow paths 210 and 220 respectively formed on the opposite side surfaces of the internal core flow path portion 200. Furthermore, the internal core 100 and the internal core flow path portion 200 may be separately provided and may be forcibly coupled to each other.

The middle pipe 500 of the hydraulic mount 10 according to the exemplary embodiment of the present disclosure is disposed between the main insulator 300 and the external pipe 600. The middle pipe 500 is located to surround the external circumferential surface of the main insulator 300. Here, the middle pipe 500 may include a sealing member 700 configured to seal the chamber 310 provided in the main insulator 300 and configured to store the mount fluid therein. The sealing member 700 may include a primary sealing portion configured to surround the external peripheral surface of the chamber 310 and a secondary sealing portion configured to surround all of the open areas of the front and rear end portions of the main insulator 300.

According to another exemplary embodiment of the present disclosure, as shown in FIG. 6, the internal core 100 and the internal core flow path portion 200 may be integrally injection-molded to implement a hydraulic mount 10′. In the instant case, since there is no increase in the number of portions, it is possible to achieve cost reduction.

When the internal core 100 and the internal core flow path portion 200 are integrally molded in the present manner, an assembly process may be simply performed. The plates 400 coupled to the opposite side surfaces of the internal core flow path portion 200 may also be formed through an integral injection molding method.

Hereinafter, an assembly process of the hydraulic mount 10 will be described with reference to FIG. 2.

In the hydraulic mount 10 according to an exemplary embodiment of the present disclosure, first, the internal core flow path portion 200 is forcibly coupled to and assembled with the internal core 100. Thereafter, the plates 400 respectively surround one surface and the other surface of the internal core flow path portion 200. Accordingly, the plates 400 are reliably fixed to the internal core flow path portion 200 through a riveting or bonding process.

The structure in which the plates 400 are assembled with the internal core flow path portion 200 is vulcanized into the main insulator 300 and is disposed in the middle pipe 500. The middle pipe 500 into which the main insulator 300 and the internal core flow path portion 200 are inserted is forcibly inserted into the external pipe 600, completing the hydraulic mount 10.

As is apparent from the above description, the present disclosure provides the following effects through the above-described configuration, combination, and usage relationship.

The present disclosure provides a hydraulic mount including a flow path formed therein, in which the hydraulic mount has a wide range of applications for directionally (upward-and-downward direction and leftward-and-rightward direction) required frequencies and provides a high damping value.

Furthermore, the hydraulic mount is configured not only to implement damping performance for two behavioral axes by applying a two-way damping structure thereto, but also to implement damping performance for a complexly generated vector directional component.

Additionally, the hydraulic mount includes a flow path structure configured to support an axial insulator bridge, including an effect of achieving improvement in axial rigidity and including a mass effect by the flow path structure. In the present manner, the hydraulic mount is configured as a mass damper and may further improve high-frequency dynamic characteristics. Through the present structural configuration, the hydraulic mount has better performance than that of the related art in terms of improvement in vibration reduction of an electric vehicle and behavior control thereof. Furthermore, there is no increase in the number of parts compared to the related art, and cost reduction is achieved by simplifying the shapes of portions.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A hydraulic mount comprising:
an internal core;
an internal core flow path portion formed on an external circumferential surface of the internal core, wherein the internal core flow path portion includes a flow path formed on the external circumferential surface of the internal core and configured to allow mount fluid to flow through the flow path; and
a main insulator located to surround the internal core flow path portion,
wherein the internal core flow path portion includes at least two flow paths respectively formed on at least two surfaces of the internal core flow path portion, and
wherein the respective at least two flow paths are formed to have a predetermined angle relative to a central axis of the internal core flow path portion.

2. The hydraulic mount of claim 1, wherein the at least two flow paths are formed so that the mount fluid introduced into each inlet of the at least two flow paths flows along the at least two flow paths adjacent to an external circumferential surface of the internal core flow path portion, and then a flow direction of the mount fluid is changed in opposite direction at a position adjacent to each outlet of the at least two flow paths.

3. The hydraulic mount of claim 1, wherein the at least two flow paths includes:
a first flow path located on a first surface among the at least two surfaces; and
a second flow path located on a second surface opposite to the first surface of the internal core flow path portion, and
wherein the first flow path and the second flow path are formed to allow the mount fluid to flow along the first surface and the second surface of the internal core flow path portion.

4. The hydraulic mount of claim 3, wherein the first flow path includes:
a first inlet configured to allow the mount fluid to be introduced into the first inlet; and
a first outlet configured to discharge the mount fluid introduced into the first inlet through the first outlet,
wherein the first inlet is located at an upper portion of the main insulator in a height direction, and the first outlet is located at a lower portion of the main insulator in the height direction.

5. The hydraulic mount of claim 3, wherein the second flow path includes:
a second inlet configured to allow the mount fluid to be introduced into the second inlet; and
a second outlet configured to discharge the mount fluid through the second outlet,
wherein the second inlet forms a predetermined angle relative to a height direction of the main insulator, and the second outlet is spaced apart from the second inlet in a state of forming an angle of 180 degrees relative to the second inlet.

6. The hydraulic mount of claim 2,
wherein the first flow path includes:
a first inlet configured to allow the mount fluid to be introduced into the first inlet; and
a first outlet configured to discharge the mount fluid introduced into the first inlet through the first outlet,
wherein the first inlet is located at an upper portion of the main insulator in a height direction, and the first outlet is located at a lower portion of the main insulator in the height direction,
wherein the second flow path includes:
a second inlet configured to allow the mount fluid to be introduced into the second inlet; and
a second outlet configured to discharge the mount fluid through the second outlet,
wherein the second inlet forms a predetermined angle relative to the height direction of the main insulator, and the second outlet is spaced apart from the second inlet in a state of forming an angle of 180 degrees relative to the second inlet, and
wherein the first and second flow paths are formed so that the mount fluid introduced into each inlets the first and second flow paths flows along the first and second flow paths adjacent to the external circumferential surface of the internal core flow path portion, and then a flow direction of the mount fluid is changed in opposite direction at a position adjacent to each outlet of the first and second flow paths.

7. The hydraulic mount of claim 1, wherein each of the at least two flow paths has a diameter or a length determined depending on an amount of the mount fluid flowing through each of the at least two flow paths, and damping or target frequency is set depending on the diameter or the length of each of the at least two flow paths.

8. The hydraulic mount of claim 1, further including plates each covering a corresponding one of surfaces of the at least two flow paths.

9. The hydraulic mount of claim 1, wherein the main insulator includes chambers fluidically connected to the respective at least two flow paths.

10. The hydraulic mount of claim 9, further including a middle pipe located to surround an external circumferential surface of the main insulator.

11. The hydraulic mount of claim 10, further including a sealing member located on the middle pipe and configured to face the chambers of the main insulator.

12. The hydraulic mount of claim 11, wherein the sealing member includes a primary sealing portion surrounding an external peripheral surface of the chambers and a secondary sealing portion surrounding all of open areas of front and rear end portions of the main insulator.

13. The hydraulic mount of claim 9, further including an external pipe located to surround an external circumferential surface of the middle pipe.

14. The hydraulic mount of claim 1, wherein the at least two flow paths of the internal core flow path portion are respectively formed to be recessed in the at least two surfaces of the internal core flow path portion.
